(19) United States
(12) Patent Application Publication
(10) Pub. No.: US 2007/0294452 A1
(43) Pub. Date: Dec. 20, 2007

(54) EXTERNAL MULTIMEDIA EXPANSION DEVICE

(75) Inventors: Nai-Wei Chiu, Taipei (TW); Yu-Liang Liu, Taipei (TW); Kuo-Chung Kao, Taipei (TW); Yu-Hsuan Lai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/762,080

(22) Filed: Jun. 13, 2007

(30) Foreign Application Priority Data
Jun. 14, 2006 (TW) 95121197
Sep. 8, 2006 (TW) 95133172

(51) Int. Cl. G06F 13/00

(52) U.S. Cl. 710/300

(57) ABSTRACT

An external multimedia expansion device suitable for being electrically connected to a portable computer is provided. An express card is inserted into the portable computer, and the external multimedia expansion device is suitable for being electrically connected to the portable computer through the express card. The external multimedia expansion device includes a first circuit board and a transmitting cable. The first circuit board is suitable for being electrically connected to at least one processing unit, and to the express card through the transmitting cable. The transmitting cable is suitable for transmitting at least one of a high-speed signal and a universal serial bus (USB) signal, so that the performance of the portable computer can be enhanced through operating the processing unit. Since the external multimedia expansion device is suitable for transmitting the high-speed signal, the portable computer can enhance performance of its hardware through an external expansion card.

### CROSS-REFERENCE TO RELATED APPLICATION

This application claims the priority benefits of Taiwan applications serial no. 95121197, filed Jun. 14, 2006 and serial no. 95133172, filed Sep. 8, 2006. All disclosures of the Taiwan applications are incorporated herein by reference.

### BACKGROUND OF THE INVENTION

1. Field of the Invention

The present invention relates to a multimedia expansion device, and particularly to an external multimedia expansion device.

2. Description of Related Art

With the advancement of the electronic technologies, portable electronic devices e.g. notebooks have been widely adopted. The main difference between portable electronic devices and other non-portable types of electronic devices is that portable electronic devices aim for portability so that they must be designed to be as light and compact as possible. However, to reduce the volume of a portable electronic device for the purpose of portability, the hardware performance of the portable electronic device is often compromised when compared with the non-portable counterpart.

For example, to enhance the portability of a notebook, built-in multimedia devices such as a built-in audio chip and a built-in display chip are normally installed on the mother board. Furthermore, due to volume consideration, additional expansion sockets for improving the performance of these multimedia devices are not installed normally. Thus, when a user needs to use high-grade softwares such as a 3D drafting software or a 3D game software, the notebook may not have sufficient hardware capacity to execute the software smoothly. In other words, when the hardware of the portable electronic device does not have a sufficient performance capacity, the only solution is to switch to a higher-grade portable electronic device or to use a less portable electronic device that has a higher hardware performance capacity.

However, to a portable electronic device user, the inability to expand the hardware not only leads to inconvenience, but also increases the user's running cost.

### SUMMARY OF THE INVENTION

Accordingly, the present invention is directed to an external multimedia expansion device capable of resolving problems in the conventional technique.

As embodied and broadly described herein, the present invention discloses an external multimedia expansion device suitable for being electrically connected to a portable computer. An express card is inserted into the portable computer, and the external multimedia expansion device is suitable for being electrically connected to the portable computer through the express card. The external multimedia expansion device includes a first circuit board and a transmitting cable. The first circuit board is suitable for being electrically connected to at least one processing unit, and to the express card through the transmitting cable. The transmitting cable is suitable for transmitting at least one of a high-speed signal and a universal serial bus (USB) signal, so that the performance of the portable computer can be enhanced through operating the processing unit.

In one embodiment of the present invention, said express card and said first circuit board have a transmission rate of 2.5 Gbps (giga bits per second) at least when transmitting the high-speed signal through the transmitting cable; when transmitting the USB signal, the transmission rate reaches 1.5 Mbps (mega bits per second) at least.

In one embodiment of the present invention, said transmitting cable including a first connecting member and a second connecting member is suitable for being electrically connected to the express card and the first circuit board through the first connecting member and the second connecting member, respectively.

As embodied and broadly described herein, the present invention discloses an external multimedia expansion device suitable for being electrically connected to a portable computer with an express card socket. The external multimedia expansion device comprises an express card and a first circuit board, and the express card is suitable for being inserted into the express card socket. The first circuit board is electrically connected to the express card and is suitable for being electrically connected to at least one processing unit. In addition, the first circuit board is electrically connected to the portable computer through the express card suitable for transmitting at least one of a high-speed signal and a USB signal, so that the performance of the portable computer can be enhanced through operating the processing unit.

In one embodiment of the present invention, said first circuit board has a transmission rate of 2.5 Gbps at least when transmitting the high-speed signal through the express card, and has a transmission rate of 1.5 Mbps at least when transmitting the USB signal.

In one embodiment of the present invention, said first circuit board has at least an expansion card socket suitable for inserting a second circuit board thereto.

In one embodiment of the present invention, said expansion card socket is a peripheral component interconnect express (PCI-E) socket or a mobile PCI-E module (MXM) socket.

In one embodiment of the present invention, said second circuit board is a board with a PCI-E or an MXM interface.

In one embodiment of the present invention, said processing unit is mounted to the second circuit board, so that the processing unit can be electronically connected to the first circuit board through the second circuit board.

In one embodiment of the present invention, said processing unit is directly mounted to the first circuit board so as to be electronically connected thereto.

In one embodiment of the present invention, said processing unit is a graphic processing unit (GPU) or a physics processing unit (PPU).

In one embodiment of the present invention, said external multimedia expansion device further includes a USB port. The USB port is electrically connected to the first circuit board and is suitable for transmitting the USB signal with the portable computer through the first circuit board.

In one embodiment of the present invention, said external multimedia expansion device further includes a connecting member with a USB extending interface. The connecting member with the USB extending interface are electrically connected to the first circuit board and is suitable for transmitting the USB signal with the portable computer through the first circuit board.

In one embodiment of the present invention, said external multimedia expansion device further includes a housing and a display panel. The display panel is installed on the housing so as to display system data of the portable computer.

In one embodiment of the present invention, said external multimedia expansion device further comprises a control unit for controlling an operating frequency of the processing unit.

The external multimedia expansion device of the present invention has a higher data transmission rate so that the portable computer has enhanced hardware performance by connecting to an external expansion card through the external multimedia expansion device. Moreover, the portable computer can further connect to other devices through the USB port of the external multimedia expansion device.

In order to the make aforementioned and other objects, features and advantages of the present invention comprehensible, preferred embodiments accompanied with figures are described in detail below.

### BRIEF DESCRIPTION OF THE DRAWINGS

FIG. 1 is a visual diagram illustrating an external multimedia expansion device according to a first embodiment of the present invention.

FIG. 2 is a perspective view illustrating the external multimedia expansion device and the portable computer before being assembled together according to the first embodiment of the present invention.

FIG. 3 is a perspective view illustrating an external multimedia expansion device and a portable computer before being assembled together according to a second embodiment of the present invention.

FIG. 4 is a perspective view illustrating an external multimedia expansion device and a portable computer before being assembled together according to a third embodiment of the present invention.

FIG. 5 is a perspective view illustrating an external multimedia expansion device and a portable computer before being assembled together according to a fourth embodiment of the present invention.

### DESCRIPTION OF EMBODIMENTS

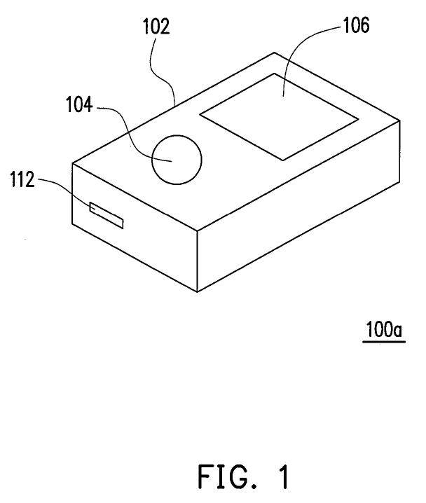

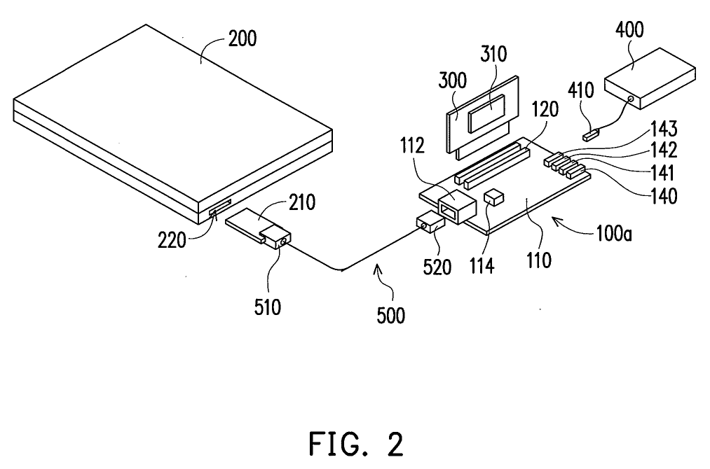

Please refer to FIGS. 1 and 2 together for a description of a first preferred embodiment of the present invention. FIG. 1 is a visual diagram illustrating an external multimedia expansion device according to a first embodiment of the present invention, and FIG. 2 is a perspective view illustrating the external multimedia expansion device and the portable computer before being assembled together according to the first embodiment of the present invention.

In FIGS. 1 and 2, the external multimedia expansion device 100a visually comprises a housing 102. The housing 102 with a control unit 104 and a display panel 106 exposes a connecting member 112 of a first circuit board 110. In addition, the external multimedia expansion device 100a further comprises the first circuit board 110, an expansion card socket 120, a universal serial bus (USB) port 140, and connecting members 141, 142, 143 with a USB extending interface.

The connecting member 104, the expansion card socket 120, the USB port 140, and the connecting members 141, 142, 143 with the USB extending interface are respectively mounted to the first circuit board 110 and are electrically connected thereto.

The expansion card socket 120 is suitable for inserting a second circuit board 300, so that the second circuit board 300 can transmit a high-speed signal with an express card 210 through the expansion card socket 120 and the first circuit board 110. The express card 210 is inserted into an express card socket 220 of the portable computer 200 and is electrically connected thereto. It should be noted that there are one expansion card socket 120 suitable for inserting one second circuit board 300 according to the present embodiment, while there may be a plurality of the expansion card sockets 120 for inserting a plurality of the second circuit boards 300 thereto according to the other embodiments.

According to the present embodiment, the high-speed signal is a peripheral component interconnect express (PCI-E) signal with a transmission rate of 2.5 Gbps, while the transmission rate may reach 4 Gbps or higher according to the other embodiments.

According to the present embodiment, the portable computer 200 is a notebook, while the portable computer 200 may be a palmtop, a tablet PC, an ultra-mobile personal computer (UMPC), a personal digital assistant (PDA), or a mobile phone according to the other embodiments.

The USB port 140 and the connecting members 141, 142, 143 with the USB extending interface are installed at one side of the first circuit board 110. Since the USB port 140 and the connecting members 141,142,143 with the USB extending interface are electrically connected to the first circuit board 110, they can transmit a USB signal with the express card 210 through the first circuit board 110. Please note that the present invention is not limited to this embodiment. For example, according to the other embodiments, the external multimedia expansion device 100a may not have the USB port 140 and the connecting members 141, 142, 143 with the USB extending interface.

The USB port 140 can be used to connect an external device 400. According to the present embodiment, the external device 400 may be electrically connected to the USB port 140 of the external multimedia expansion device 100a through a USB transmitting cable 410. After the external device 400 is connected to the USB port 140 through the USB transmitting cable 410, the portable computer 200 is capable of transmitting the USB signal with the external device 400 through the external multimedia expansion device 100a at a transmission rate of 1.5 Mbps at least. Please note that the transmission rate of transmitting the USB signal reaches 1.5 Mbps at least under a USB 1.0 transmission protocol according to the present embodiment, while the transmission rate reaches 480 Mbps at least under a USB 2.0 transmission protocol according to the other embodiments.

Only one USB port 140 is indicated in FIG. 1; however, the external multimedia expansion device 100a may comprise several USB ports 140 for integrating USB hub functions according to the other embodiments.

According to the present embodiment, the connecting members 141, 142, 143 with the USB extending interface may be radio frequency port-RF ports, audio/video port-AV ports, ports capable of connecting speakers, or other ports enabling applications of USB signals.

Thus, through the external multimedia expansion device 100a, the portable computer 200 is allowed to improve its function by connecting the external device 400, a video device, an audio device e.g. speakers or other electronic devices with the USB extending interface. For example, through the external multimedia expansion device 100a, the portable computer 200 is allowed to improve its audio/video function by connecting a television, a video recorder/player, a VCD player, a DVD player, or speakers.

According to the present embodiment, it should be noted that the expansion card socket 120 uses the PCI-E interface, and the second circuit board 300 is a circuit board with the PCI-E interface. Said second circuit board 300 is, for example, a board with the PCI-E interface. According to the other embodiments, the expansion card socket 120 may use the MXM interface. Correspondingly, the second circuit board 300 is the board with the MXM interface. Only one expansion card socket 120 is mounted to the first circuit board 110 according to the present embodiment. However, a plurality of expansion card sockets 120 may be mounted to the first circuit board 110 according to the other embodiments.

On the other hand, according to the present embodiment, a processing unit 600 is mounted to the second circuit board 300 and electrically connected thereto. The processing unit 600 may be further electrically connected to the first circuit board 110 through the second circuit board 300 and the expansion card socket 120. Accordingly, when the second circuit board 300 is inserted into the expansion card socket 120 and electrically connected thereto, the portable computer 200 is capable of enhancing its hardware performance through operating the processing unit 600 of the second circuit board 300. In other words, the portable computer 200 can enhance its hardware performance through the express card 210, the transmitting cable 500, and the external multimedia expansion device 100a attaching the second circuit board 300 thereto.

According to the present embodiment, the processing unit 600 is a graphic processing unit (GPU) or a physics processing unit (PPU), while the processing unit 600 may be other types of processing units so as to enhance processing performance of the portable computer 200 according to the other embodiments.

A more detailed description of the connection between the external multimedia expansion device 100a and the portable computer 200 is provided hereinafter.

The external multimedia expansion device 100a of the present embodiment is electrically connected to the portable computer 200 through the transmitting cable 500 with a first connecting member 510 at one end of the transmitting cable 500 and a second connecting member 520 at the other. The first connecting member 510 may be electrically connected to the express card 210, and the second connecting member 520 may be electrically connected to the connecting member 104 of the first circuit board 110 of the external multimedia expansion device 100a. Hence, the external multimedia expansion device 100a can transmit at least one of the high-speed signal or the USB signal with the portable computer 200 through the express card 210 and the transmitting cable 500. Namely, the transmitting cable 500 can be used to transmit said high-speed signal, said USB signal, or both of them in the meantime.

According to the present embodiment, the connecting members 510 and 520 respectively comprise fourteen leads in support of transmitting said two signals. On the contrary, the connecting members 510 and 520 may comprise other numbers of leads according to the other embodiments. In addition, according to the present embodiment, the connecting members 510 and 520 are both D-type connectors, while the connecting members 510 and 520 may be other types of connectors according to the other embodiments as long as the numbers of leads are sufficient enough to permit the transmission of said two signals.

Moreover, according to the present embodiment, the express card 210 inserted to the portable computer 200 is capable of supporting transmissions of two different signals. For example, the express card 210 can support a PCI-E signal and the USB signal. However, the present invention is not limited to this embodiment. The express card 210 can also support transmissions of another two different signals according to the other embodiments. For example, the express card can support the transmissions of not only the USB signal but also another high-speed signal such as an IEEE-1394 signal, an MXM signal, the PCI-E signal, or a PCMCIA signal.

Furthermore, the external multimedia expansion device 100a disclosed in the present embodiment not only enhances performance of the portable computer 200 through operating the processing unit 600 but also provides other functions.

For instance, a control chip 114 is further mounted to the first circuit board 110 and is electrically connected to the first circuit board 110, the control unit 104, and the display panel 106, respectively. The display panel 106 is used to display system data of the portable computer 200, such as an operating frequency of a central processing unit of the portable computer 200, system fan speed thereof, system temperature thereof, or use of memory thereof. According to the present embodiment, the control unit 104 is a knob which can be rotated left, right, or be pushed down.

For example, in a preset state, the control unit 104 can be rotated left or right so as to adjust the volume of the portable computer 200. Further, when the control unit 104 is rotated left or right, a corresponding signal is generated and transferred to the control chip 114, so as to adjust the volume of the portable computer 200 through the transmitting cable 500 and the express card 210. In addition, when the control unit 104 is pushed once, another corresponding signal generated by the control unit 104 is transferred to the control chip 114, so as to adjust the operating frequency of the portable computer 200 through the transmitting cable 500 and the express card 210. Here, the operating frequency can be increased as the control unit 104 is rotated right, while the operating frequency can be decreased as the control unit is rotated left. Likewise, when the control unit 104 is pushed twice, the corresponding signal generated by the control unit 104 is transferred to the control chip 114, so as to adjust the system fan speed of the portable computer 200 through the transmitting cable 500 and the express card 210. Here, the system fan speed can be increased as the control unit 104 is rotated right, while the system fan speed can be decreased as the control unit is rotated left.

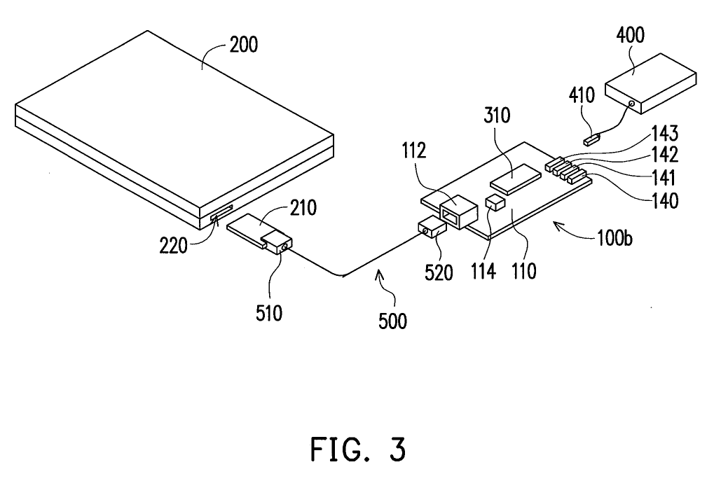

FIG. 3 is a perspective view illustrating an external multimedia expansion device and a portable computer before being assembled together according to a second embodiment of the present invention. Referring to FIG. 3, the structure of an external multimedia expansion device 100b is substantially equal to that of the external multimedia expansion device 100a in FIG. 2. The difference lies in the processing unit 600 directly mounted to the first circuit board 110 and electrically connected thereto.

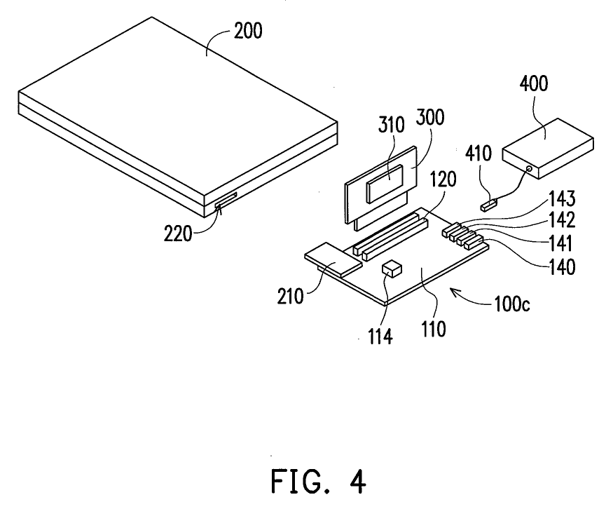

FIG. 4 is a perspective view illustrating an external multimedia expansion device and a portable computer before being assembled together according to a third embodiment of the present invention. Referring to FIG. 4, the structure of an external multimedia expansion device 100c is substantially equal to that of the external multimedia expansion device 100a in FIG. 2. The difference lies in the express card 210 electronically connected to the external multimedia expansion device 1 φc directly rather than connected to the external multimedia expansion device 100a through the transmitting cable 500 as shown in FIG. 2.

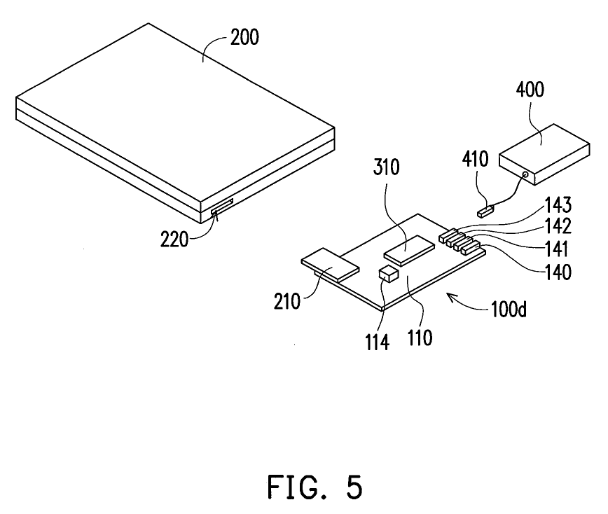

FIG. 5 is a perspective view illustrating an external multimedia expansion device and a portable computer before being assembled together according to a fourth embodiment of the present invention. Referring to FIG. 5, the structure of an external multimedia expansion device 100d is substantially equal to that of the external multimedia expansion device 100c in FIG. 4. The difference lies in the processing unit 600 directly mounted to the first circuit board 110 and electrically connected thereto.

In summary, the external multimedia expansion device disclosed in the preferred embodiments of the present invention has a higher transmission rate. Therefore, after the external multimedia expansion device is connected to the portable computer, the portable computer has enhanced hardware performance through external connections. For example, the display or the processing performance of the portable computer can be boosted when the external multimedia expansion device is connected to the portable computer, or the second circuit board connected to the external multimedia expansion device is configured with a display card or a physics acceleration card.

In addition, the external multimedia expansion device comprises the USB port. Accordingly, the portable computer can enhance its performance by connecting other external devices with USB extending interfaces through the external multimedia expansion device. For example, through the external multimedia expansion device, the portable computer can further connect to an external hard drive or a printer with the USB extending interface so as to enlarge the capacity of the hard drive or add a printing feature.

Although the present invention has been disclosed above by the preferred embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. An external multimedia expansion device suitable for being electrically connected to a portable computer having an express card, through which the external multimedia expansion device is suitable for being electrically connected to the portable computer, wherein the external multimedia expansion device comprises:
a first circuit board suitable for being electrically connected to at least a processing unit; and
a transmitting cable, wherein the first circuit board is suitable for being electrically connected to the express card through the transmitting cable, and the transmitting cable is suitable for transmitting at least one of a high-speed signal and a universal serial bus (USB) signal so as to enhance performance of the portable computer by operating the processing unit.

2. The external multimedia expansion device of claim 1, wherein the first circuit board has at least an expansion card socket suitable for inserting a second circuit board thereto.

3. The external multimedia expansion device of claim 2, wherein the expansion card socket is a peripheral component interconnect express (PCI-E) socket or a mobile PCI-E module (MXM) socket.

4. The external multimedia expansion device of claim 2, wherein the second circuit board is a board with a PCI-E or an MXM interface.

5. The external multimedia expansion device of claim 2, wherein the processing unit is mounted to the second circuit board so as to be electrically connected to the first circuit board through the second circuit board.

6. The external multimedia expansion device of claim 1, wherein the processing unit is directly mounted to the first circuit board so as to be electrically connected thereto.

7. The external multimedia expansion device of claim 1, wherein the processing unit is a graphic processing unit (GPU) or a physics processing unit (PPU).

8. The external multimedia expansion device of claim 1, wherein the express card and the first circuit board have a transmission rate of 2.5 Gbps at least when transmitting the high-speed signal through the transmitting cable, and have a transmission rate of 1.5 Mbps at least when transmitting the USB signal.

9. The external multimedia expansion device of claim 1, wherein the transmitting cable comprising a first connecting member and a second connecting member is suitable for being electrically connected to the express card and to the first circuit board through the first connecting member and the second connecting member, respectively.

10. The external multimedia expansion device of claim 1, further comprising a USB port electrically connected to the first circuit board and suitable for transmitting the USB signal with the portable computer through the first circuit board.

11. The external multimedia expansion device of claim 1, further comprising a connecting member with a USB extending interface, wherein the connecting member with the USB extending interface is electrically connected to the first circuit board and is suitable for transmitting the USB signal with the portable computer through the first circuit board.

12. The external multimedia expansion device of claim 1, further comprising a housing and a display panel, wherein the display panel is installed on the housing so as to display system data of the portable computer.

13. The external multimedia expansion device of claim 1, further comprising a control unit for controlling an operating frequency of the processing unit.

14. An external multimedia expansion device suitable for being electrically connected to a portable computer having an express card socket, wherein the external multimedia expansion device comprises:
an express card suitable for being inserted into the express card socket; and
a first circuit board electrically connected to the express card and suitable for being electrically connected to at least one processing unit, wherein the first circuit board is further electrically connected to the portable computer through the express card, and the express card is suitable for transmitting at least one of a high-speed signal and a universal serial bus (USB) signal so as to enhance performance of the portable computer by operating the processing unit.

15. The external multimedia expansion device of claim 14, wherein the first circuit board has at least an expansion card socket suitable for inserting a second circuit board.

16. The external multimedia expansion device of claim 15, wherein the expansion card socket is a peripheral component interconnect express (PCI-E) socket or a mobile PCI-E module (MXM) socket.

17. The external multimedia expansion device of claim 15, wherein the second circuit board is a display card with a PCI-E or an MXM interface.

18. The external multimedia expansion device of claim 15, wherein the processing unit is mounted to the second circuit board so as to be electrically connected to the first circuit board through the second circuit board.

19. The external multimedia expansion device of claim 14, wherein the processing unit is directly mounted to the first circuit board so as to be electrically connected thereto.

20. The external multimedia expansion device of claim 14, wherein the processing unit is a graphic processing unit (GPU) or a physics processing unit (PPU).

21. The external multimedia expansion device of claim 14, wherein the first circuit board has a transmission rate of 2.5 Gbps at least when transmitting the high-speed signal through the express card, and has a transmission rate of 1.5 Mbps at least when transmitting the USB signal.

22. The external multimedia expansion device of claim 14, further comprising a USB port electrically connected to the first circuit board and suitable for transmitting the USB signal with the portable computer through the first circuit board.

23. The external multimedia expansion device of claim 14, further comprising a connecting member with a USB extending interface, wherein the connecting member with the USB extending interface is electrically connected to the first circuit board and suitable for transmitting the USB signal with the portable computer through the first circuit board.

24. The external multimedia expansion device of claim 14, further comprising a housing and a display panel, wherein the display panel is installed on the housing so as to display system data of the portable computer.

25. The external multimedia expansion device of claim 14, further comprising a control unit for controlling an operating frequency of the processing unit.
